(19) United States
(12) Patent Application Publication
(10) Pub. No.: US 2016/0092441 A1
(43) Pub. Date: Mar. 31, 2016

(54) File Acquiring Method and Device

(71) Applicant: Huawei Device Co., Ltd., Shenzhen (CN)

(72) Inventor: Xinsheng Zhang, Wuhan (CN)

(21) Appl. No.: 14/965,110

(22) Filed: Dec. 10, 2015

Related U.S. Application Data
(63) Continuation of application No. PCT/CN2014/084002, filed on Aug. 8, 2014.

(30) Foreign Application Priority Data
Aug. 8, 2013 (CN) 201310343952.9

(51) Int. Cl. G06F 17/30

(52) U.S. Cl. CPC G06F 17/301

(57) ABSTRACT

A file acquiring method and device. The method includes detecting, by a mobile terminal, an updated extended storage medium, where the updated extended storage medium includes at least one file; when an instruction is received, acquiring, by the mobile terminal, stored file information according to the instruction; and acquiring, by the mobile terminal from the updated extended storage medium according to the stored file information, a file matching a first file, and using the file as a file corresponding to the instruction, where the first file is a file selected from an extended storage medium that has not been updated, where the file information is used for guiding the mobile terminal to acquire, from a partition of the extended storage medium, the file matching the first file, and use the file as the file corresponding to the instruction.

### CROSS-REFERENCE TO RELATED APPLICATIONS

This application is a continuation of International Application No. PCT/CN2014/084002, filed on Aug. 8, 2014, which claims priority to Chinese Patent Application No. 201310343952.9, filed on Aug. 8, 2013, both of which are hereby incorporated by reference in their entireties.

### TECHNICAL FIELD

The present disclosure relates to the field of communications application technologies, and in particular, to a file acquiring method and device.

### BACKGROUND

In modern mobile communications, in order to extend a size of memory of a mobile terminal, a user uses an extended storage medium such as a secure digital memory card (SD) to extend the memory of the mobile terminal. Using a mobile phone as an example, as an SD card is used, it is extremely convenient for a user to use the mobile phone as a storage device, and for setting on the mobile phone, the user can customize music, a picture, and the like that are stored in the SD card as customized setting options such as a ringtone and a desktop of the mobile phone according to a preference of the user. However, after the user replaces the SD card, a ringtone of the mobile phone cannot be restored to the ringtone that is set in a customized manner according to the music stored in the last SD card, but can only change to a system default ringtone. In addition, after the user removes the SD card, even though the user inserts the SD card again, the ringtone of the mobile phone also changes to the system default ringtone, and the music, which is previously set in a customized manner, in the SD card cannot be restored to the ringtone of the mobile phone, thereby degrading the operation experience of the user. Similarly, after the SD card is replaced, a desktop picture of the mobile phone cannot be restored to the picture previously stored in the SD card, and in addition, after a picture in the SD card is set as the desktop, after the SD card is removed and inserted again, the desktop picture of the mobile phone cannot be restored to the previously set picture.

### SUMMARY

Embodiments of the present disclosure provide a file acquiring method and device, which makes it possible, in a case in which an extended storage medium is updated, for a mobile terminal to restore a customized setting performed on a file in an extended storage medium that has not been updated.

In order to achieve the foregoing objective, the following technical solutions are used in the embodiments of the present disclosure.

According to a first aspect, a file acquiring method is provided, including detecting, by a mobile terminal, an updated extended storage medium, where the updated extended storage medium includes at least one file; when an instruction is received, acquiring, by the mobile terminal, stored file information according to the instruction; and acquiring, by the mobile terminal from the updated extended storage medium according to the stored file information, a file matching a first file, using the file as a file corresponding to the instruction, where the first file is a file selected from an extended storage medium that has not been updated, and the file information is used for guiding the mobile terminal to acquire, from a partition of the extended storage medium, the file matching the first file, and use the file as the file corresponding to the instruction.

With reference to the first aspect, in a first possible implementation manner, the method further includes using the acquired file matching the first file as the file corresponding to the instruction when the updated extended storage medium has the file matching the first file.

With reference to the first aspect, in a second possible implementation manner, the method further includes using an acquired file meeting a predetermined condition as the file corresponding to the instruction when the updated extended storage medium does not have the file matching the first file.

With reference to the first aspect, the first possible implementation manner of the first aspect, or the second possible implementation manner of the first aspect, in a third possible implementation manner, before the detecting, by a terminal, an updated extended storage medium, the method further includes receiving an instruction of a user, and setting a file, in the extended storage medium that has not been updated, as the first file; and storing file information of the first file, where the file information is used for guiding the mobile terminal to acquire, from the partition of the extended storage medium, the file matching the first file.

With reference to the first aspect, the first possible implementation manner of the first aspect, the second possible implementation manner of the first aspect, or the third possible implementation manner of the first aspect, in a fourth possible implementation manner, the stored file information includes a file path and a file name of the first file.

With reference to the first aspect, the first possible implementation manner of the first aspect, the second possible implementation manner of the first aspect, the third possible implementation manner of the first aspect, or the fourth possible implementation manner of the first aspect, in a fifth possible implementation manner, the stored file information further includes a uniform resource identifier, and the uniform resource identifier is associated with the file path and the file name of the first file.

With reference to the second possible implementation manner, in a sixth possible implementation manner, the using an acquired file meeting a predetermined condition as the file corresponding to the instruction when the updated extended storage medium does not have the file matching the first file includes acquiring attribute information of the at least one file in the updated extended storage medium; acquiring a degree of matching between the at least one file and the first file according to a preset rule; and using a file, a degree of matching between which and the first file is greater than or equal to a preset threshold, in the at least one file as the file corresponding to the instruction, or using a file, a degree of matching between which and the first file is the highest, in the at least one file as the file corresponding to the instruction.

With reference to the sixth possible implementation manner, in a seventh possible implementation manner, the method further includes, when the instruction received by the mobile terminal includes generating a ringtone, the file corresponding to the instruction includes a music file corresponding to the ringtone, and the acquiring attribute information of the at least one file in the updated extended storage medium includes acquiring at least one of a language, a style, an album, an artist, and a data size of a music file in the at least one file in the updated extended storage medium; or, when the instruction received by the mobile terminal includes displaying a desktop, the file corresponding to the instruction includes a picture file corresponding to the desktop, and the acquiring attribute information of the at least one file in the updated extended storage medium includes acquiring at least one of a style, a subject, and a data size of a picture file in the at least one file in the updated extended storage medium.

According to a second aspect, a mobile terminal is provided, including a detecting unit configured to detect an updated extended storage medium, where the updated extended storage medium includes at least one file; an acquiring unit configured to, when an instruction is received, acquire stored file information according to the instruction; and a configuration unit configured to acquire, from the updated extended storage medium according to the stored file information, a file matching a first file, and use the file as a file corresponding to the instruction, where the first file is a file selected from an extended storage medium that has not been updated, and the file information is used for guiding the mobile terminal to acquire, from a partition of the extended storage medium, the file matching the first file, and use the file as the file corresponding to the instruction.

With reference to the second aspect, in a first possible implementation manner, the configuration unit is configured to use the acquired file matching the first file as the file corresponding to the instruction when the updated extended storage medium has the file matching the first file.

With reference to the second aspect, in a second possible implementation manner, the configuration unit is configured to use an acquired file meeting a predetermined condition as the file corresponding to the instruction when the updated extended storage medium does not have the file matching the first file.

With reference to the second aspect, the first possible implementation manner of the second aspect, or the second possible implementation manner of the second aspect, in a third possible implementation manner, the mobile terminal further includes a setting unit configured to, before the terminal detects the updated extended storage medium, receive an instruction of a user, and set a file, in the extended storage medium that has not been updated, as the first file; and a storage unit configured to store file information of the first file, where the file information is used for guiding the mobile terminal to acquire, from the partition of the extended storage medium, the file matching the first file.

With reference to the second aspect, the first possible implementation manner of the second aspect, the second possible implementation manner of the second aspect, or the third possible implementation manner of the second aspect, in a fourth possible implementation manner, the stored file information includes a file path and a file name of the first file.

With reference to the second aspect, the first possible implementation manner of the second aspect, the second possible implementation manner of the second aspect, or the third possible implementation manner of the second aspect, or the fourth possible implementation manner of the second aspect, in a fifth possible implementation manner, the stored file information further includes a uniform resource identifier, and the uniform resource identifier is associated with the file path and the file name of the first file.

With reference to the second possible implementation manner, in a sixth possible implementation manner, the configuration unit includes an acquiring subunit configured to acquire attribute information of the at least one file in the updated extended storage medium; a matching subunit configured to acquire a degree of matching between the at least one file and the first file according to a preset rule; and a configuration subunit configured to use a file, a degree of matching between which and the first file is greater than or equal to a preset threshold, in the at least one file as the first file, or use a file, a degree of matching between which and the first file is the highest, in the at least one file as the first file.

With reference to the sixth possible implementation manner, in a seventh possible implementation manner, when the instruction received by the mobile terminal includes generating a ringtone, the file corresponding to the instruction includes a music file corresponding to the ringtone, and the acquiring subunit is configured to acquire at least one of a language, a style, an album, an artist, and a data size of a music file in the at least one file in the updated extended storage medium; or, when the instruction received by the mobile terminal includes displaying a desktop, the file corresponding to the instruction includes a picture file corresponding to the desktop, and the acquiring subunit is configured to acquire at least one of a style, a subject, and a data size of a picture file in the at least one file in the updated extended storage medium.

According to the file acquiring method and device that are provided in the embodiments of the present disclosure, after an updated extended storage medium is detected, when a mobile terminal receives an instruction, the mobile terminal acquires stored file information according to the instruction, and the mobile terminal may acquire, from the updated extended storage medium according to the stored file information, a file matching a first file, and use the file as a file corresponding to the instruction, where the first file is a file selected from an extended storage medium that has not been updated. The file matching the first file may be acquired from the updated extended storage medium and used as the file corresponding to the instruction, which can make it possible, in a case in which an extended storage medium is replaced, for a mobile terminal to restore a customized setting performed by a user on a file in an extended storage medium that has not been updated, thereby improving operation experience of the user.

### BRIEF DESCRIPTION OF THE DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of a file acquiring method according to an embodiment of the present disclosure;

FIG. 2 is a schematic flowchart of another file acquiring method according to an embodiment of the present disclosure;

FIG. 3 is a schematic structural diagram of a mobile terminal according to an embodiment of the present disclosure;

FIG. 4 is a schematic structural diagram of another mobile terminal according to an embodiment of the present disclosure;

FIG. 5 is a schematic structural diagram of still another mobile terminal according to an embodiment of the present disclosure; and

FIG. 6 is a schematic structural diagram of a mobile terminal according to another embodiment of the present disclosure.

### DETAILED DESCRIPTION

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

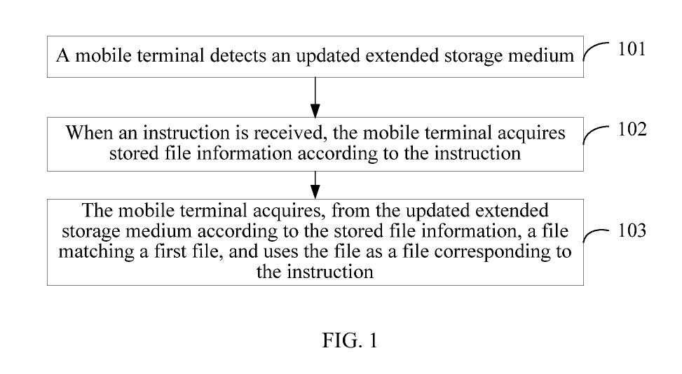

A file acquiring method provided in an embodiment of the present disclosure is applicable to any mobile terminal, such as a mobile phone or a tablet computer. As shown in FIG. 1, specific steps are as follows.

101: A mobile terminal detects an updated extended storage medium.

The updated extended storage medium includes at least one file.

An extended storage medium may include an SD or a flash memory (e.g., a tflash) card.

Herein, a description is made by using an example in which the mobile terminal is a mobile phone and the extended storage medium is an SD card. The SD card includes at least one file, such as a music file, a picture file, a video file, a third-party software file, and a system file. That the mobile phone detects that there is an updated SD card includes at least two cases: (1) an SD card is replaced with another SD card in the mobile phone; and (2) an original SD card in the mobile phone is inserted back again after being removed.

102: When an instruction is received, the mobile terminal acquires stored file information according to the instruction.

The instruction received by the mobile terminal includes at least generating a ringtone or a desktop. Using the mobile phone as an example, when the mobile phone receives a telephone call from another mobile phone, the mobile phone receives an instruction for generating a ringtone, or after the mobile phone is powered on, the mobile phone receives an instruction for displaying a desktop.

After the foregoing instruction is received, the mobile terminal acquires the stored file information according to the instruction.

103: The mobile terminal acquires, from the updated extended storage medium according to the stored file information, a file matching a first file, and uses the file as a file corresponding to the instruction.

For example, when the instruction received by the mobile phone includes generating a ringtone, the file corresponding to the instruction includes a music file corresponding to the ringtone; or when the instruction received by the mobile phone includes displaying a desktop, the file corresponding to the instruction includes a picture file corresponding to the desktop, where the music file may be used as a ringtone to remind a user to answer a call, or read a short message service message, or remind a user to get up; and the picture file may be used for a desktop display. Certainly, the instruction is not limited thereto, and may also include displaying an associated picture in contact information. In addition, the file corresponding to the instruction is not limited to the music file and the picture file, and may also include a video file, and the like.

The first file is a file selected from an extended storage medium that has not been updated. For example, before an SD card is updated, a user selects a music file or a picture file in the SD card that has not been updated and sets the music file or the picture file as a customized ringtone or desktop, and the music file or the picture file selected as the customized ringtone or desktop is the first file.

A person skilled in the art may understand that the first file also corresponds to the instruction only before the extended storage medium is updated. For example, a first file “Black Tangerine” is a music file selected from an SD card that has not been updated, and before the SD card is updated, the first file also corresponds to a ringtone.

The file information is used for guiding the mobile terminal to acquire, from a partition of the extended storage medium, the file matching the first file, and use the file as the file corresponding to the instruction. For example, because the SD card has been updated, to determine whether the first file “Black Tangerine” originally used as the ringtone can still be used as the ringtone, the mobile phone needs to determine, from the updated SD card, whether the music file matching “Black Tangerine” exists.

The stored file information includes a file path and a file name of the first file. In this way, the mobile terminal may acquire, from the updated extended storage medium according to the file path and the file name, the file matching the first file.

Optionally, the stored file information includes a uniform resource identifier, a file path, and a file name, where the uniform resource identifier is associated with the file path and the file name of the first file. The uniform resource identifier may be stored as an identifier (ID) in the mobile terminal, such as 01. In this way, the mobile terminal may acquire, according to the stored uniform resource identifier, the file path and the file name of the first file that correspond to the uniform resource identifier, so as to acquire, from the updated extended storage medium according to the acquired file path and file name, the file matching the first file.

In the prior art, before the mobile terminal updates the extended storage medium (which includes that a same extended storage medium is inserted again after being removed, or is replaced with another extended storage medium), if a file in the extended storage medium is set by a user as the first file in a customized manner, for example, a music file is set as a ringtone, and after the mobile terminal updates the extended storage medium, the terminal does not acquire, from a partition of the updated extended storage medium, the file matching the first file, but can only use a system default file.

According to the file acquiring method that is provided in this embodiment of the present disclosure, after an updated extended storage medium is detected, when a mobile terminal receives an instruction, the mobile terminal acquires stored file information according to the instruction, and the mobile terminal may acquire, from the updated extended storage medium according to the stored file information, a file matching a first file, and use the file as a file corresponding to the instruction, where the first file is a file selected from an extended storage medium that has not been updated. The file matching the first file may be acquired from the updated extended storage medium and used as the file corresponding to the instruction, which can make it possible, in a case in which an extended storage medium is replaced, for a mobile terminal to restore a customized setting performed by a user on a file in an extended storage medium that has not been updated, thereby improving operation experience of the user.

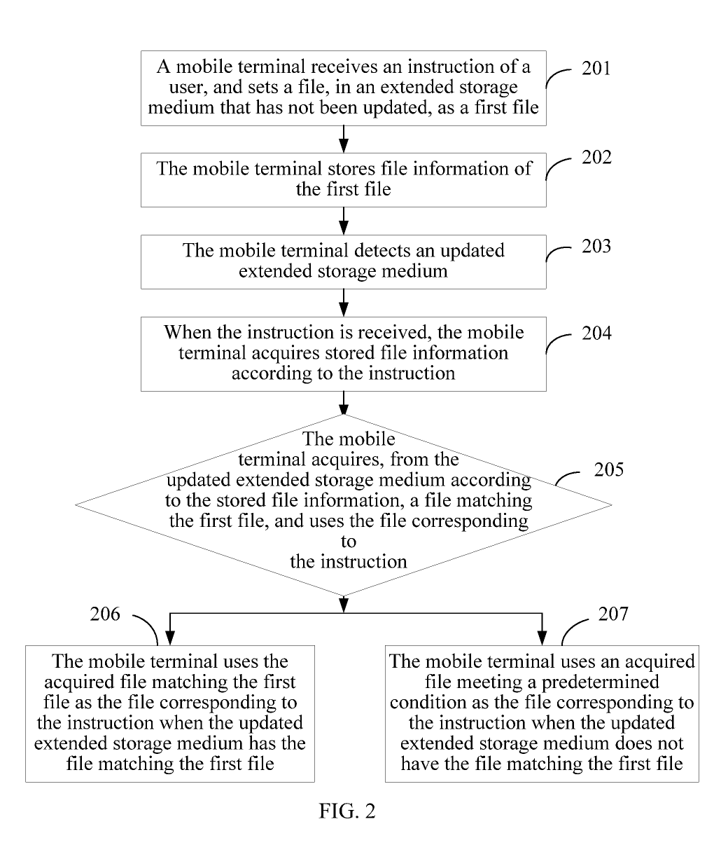

As shown in FIG. 2, an embodiment of the present disclosure provides another file acquiring method. As shown in FIG. 2, specific steps are as follows.

201: A mobile terminal receives an instruction of a user, and sets a file, in an extended storage medium that has not been updated, as a first file.

Herein, that the mobile terminal is a mobile phone and an extended storage medium is an SD card is used as an example. After the mobile phone receives a setting instruction of the user, a music file in a current SD card (which is also referred to as a first SD card in the following), such as “Love Before BC”, is set as a ringtone, and the music file “Love Before BC” is the first file.

202: The mobile terminal stores file information of the first file.

The file information is used for guiding the mobile terminal to acquire, from a partition of an extended storage medium, a file matching the first file. The mobile phone stores file information of the music file that is set as the ringtone, such as a file path data/sd/ and a file name “Love Before BC”. In this way, the mobile phone stores, for example, in a local database of the mobile phone, the path and the file name of the music file used as the ringtone in the first SD card, so that when the first SD card is replaced with a second SD card in the future, or when the first SD card is inserted back again after being removed, the mobile terminal may be guided to acquire the ringtone from the partition of the extended storage medium.

Optionally, the file information stored in the mobile phone may further include a uniform resource identifier, such as 01, the file path, and the file name, and 01 corresponds to the file path data/sd/ and the file name “Love Before BC”. In this way, the mobile phone stores, for example, in the local database of the mobile phone, the uniform resource identifier, and the file path and the file name of the first file that are associated with the uniform resource identifier, so that when the first SD card is replaced with a second SD card in the future, or when the first SD card is inserted back again after being removed, the mobile terminal may be guided to acquire the ringtone from the partition of the extended storage medium.

203: The mobile terminal detects an updated extended storage medium.

The updated extended storage medium includes at least one file.

For example, the SD card includes at least one file, such as a music file, a picture file, a video file, a third-party software file, and a system file. That the mobile phone detects that there is an updated SD card includes at least two cases: (1) an SD card is replaced with another SD card in the mobile phone; and (2) an original SD card in the mobile phone is inserted back again after being removed.

204: When the instruction is received, the mobile terminal acquires stored file information according to the instruction.

For example, when the mobile phone receives a telephone call from another mobile phone, the mobile phone receives an instruction for generating a ringtone, and the mobile phone acquires, according to the instruction, the file information stored in step 202, so as to perform the following step 205.

205: The mobile terminal acquires, from the updated extended storage medium according to the stored file information, a file matching the first file, and uses the file as a file corresponding to the instruction.

The mobile phone acquires, from the updated SD card according to the stored file information, such as the file path data/sd/ and the file name “Love Before BC”, a music file matching “Love Before BC”, and uses the music file as the ringtone; or the mobile phone may find the corresponding file path data/sd/ and file name “Love Before BC” according to the stored uniform resource identifier 01, and acquire, from the updated SD card, a music file matching “Love Before BC”, and use the music file as the ringtone.

If the mobile phone can acquire, from the updated SD card, the file matching the first file, step 206 is performed; otherwise, step 207 is performed.

206: The mobile terminal uses the acquired file matching the first file as the file corresponding to the instruction when the updated extended storage medium has the file matching the first file.

According to the stored file information, the mobile phone searches the updated SD card for determining whether the updated SD card has a music file the same as “Love Before BC”, and if the updated SD card has the music file of “Love Before BC”, the music file of “Love Before BC” is used as the music file corresponding to the ringtone. Then, a ringing ringtone of the mobile phone is music of “Love Before BC” instead of music of a system default ringtone.

207: The mobile terminal uses an acquired file meeting a predetermined condition as the file corresponding to the instruction when the updated extended storage medium does not have the file matching the first file.

According to the stored file information, the mobile phone searches the updated SD card for whether the updated SD card has a music file the same as “Love Before BC”, and if the updated SD card does not have the music file of “Love Before BC”, the mobile phone uses a music file, which meets the predetermined condition, in the updated SD card as the ringtone.

That the mobile terminal uses the acquired file meeting the predetermined condition as the file corresponding to the instruction includes:

207a: The mobile terminal acquires attribute information of at least one file in the updated extended storage medium.

When the instruction received by the mobile terminal includes generating a ringtone, the file corresponding to the instruction includes a music file corresponding to the ringtone, and acquiring the attribute information of the at least one file in the updated extended storage medium includes acquiring at least one of a language, a style, an album, an artist, and a data size of a music file in the at least one file in the updated extended storage medium, where the language may include Chinese, English, Korean, and the like, the style may include rock and roll, jazz, popular, and the like, the album may be an album in which the music file is located, the artist may be a singer of the music file, the data size includes a size of the music file, such as 4.0 megabytes (MB); or, when the instruction received by the mobile terminal includes displaying a desktop, the file corresponding to the instruction includes a picture file corresponding to the desktop, and acquiring the attribute information of the at least one file in the updated extended storage medium includes acquiring at least one of a style, a subject, and a data size of a picture file in the at least one file in the updated extended storage medium, where the style may be a person, a landscape, and the like, the subject may be a beach, a lake, the blue sky, a building (a landscape is used as an example), and the like, and the data size includes a size of the picture file.

207b: The mobile terminal acquires a degree of matching between the at least one file and the first file according to a preset rule.

207c: The mobile terminal uses a file, a degree of matching between which and the first file is greater than or equal to a preset threshold, in the at least one file as the file corresponding to the instruction, or uses a file, a degree of matching between which and the first file is the highest, in the at least one file as the file corresponding to the instruction.

207a to 207c are described in the following by using a specific example.

For example, when an SD card in the mobile phone is replaced with a new SD card, and the music file the same as “Love Before BC” cannot be found in the new SD card, the mobile phone may use a music file, a similarity between which and “Love Before BC” is high, in music files of the new SD card as the music file corresponding to the ringtone.

The mobile phone first acquires attribute information of all music files in the SD card, such as at least one of a language, a style, an album, an artist, and a data size.

Then, the mobile phone calculates a degree of matching between each music file and “Love Before BC” according to the preset rule, and uses a music file, a degree of matching between which and “Love Before BC” is greater than or equal to the predetermined threshold, as the music file corresponding to the ringtone, or uses a music file, a degree of matching between which and “Love Before BC” is the highest, as the music file corresponding to the ringtone. The preset rule may be set as required, as long as a music file, a similarity between which and “Love Before BC” is high, can be found. For example, each piece of corresponding attribute information may be compared, more consistent attribute information indicates a higher degree of matching; if there is “Simple Love” in the SD card, because both “Simple Love” and “Love Before BC” are Chinese (language), r&b (style), recorded in Fantasy (a same album), sang by Jay Chou (an artist), and are about 5.0 MB, each attribute is consistent, a degree of matching is very high, and “Simple Love” may be used as the music file corresponding to the ringtone. Then, a ringing ringtone of the mobile phone is music of “Simple Love” instead of music of a system default ringtone. For another example, a weight may be further set for an attribute, and attribute information having a higher weight indicates that a user thinks more of the attribute information. For example, if preset weights of a style and an artist are high, for example, each accounts for 35%, and weights of a language, an album, and a data size are low, for example, each accounts for 10%, compared with a music file having a same language, belonging to a same album, and having an almost same data size, a music file belonging to a same style and artist has a higher degree of matching. The preset rule is not limited herein.

A threshold may be preset for the mobile phone, and a music file with a degree of matching exceeding the threshold may be used as the music file corresponding to the ringtone. If there is more than one music file with a degree of matching exceeding the threshold, a music file with a degree of matching is the highest may be automatically selected, or a user may select a music file. Certainly, a threshold may not be preset for the mobile phone, and the mobile phone automatically selects a music file with a degree of matching is the highest, which is not limited in the present disclosure.

Even though a language, a style, an album, an artist, and a data size are used as an example of the attribute information in this embodiment of the present disclosure, the attribute information is not limited, and other attribute information may be added. In an actual application, there may also be less attribute information, which is not limited either.

The file acquiring method provided in this embodiment of the present disclosure may be further applicable to a scenario of acquiring a picture file as a desktop, and a related process is similar to the foregoing process of acquiring a music file as a ringtone, which is not described in detail herein.

Further, after the mobile terminal uses the acquired file meeting the predetermined condition as the file corresponding to the instruction, the method may further include that the mobile terminal stores updated file information. In this way, a customized setting performed this time may be restored after the extended storage medium is updated next time.

Further, if the mobile terminal does not acquire the file meeting the predetermined condition as the file corresponding to the instruction, the method may further include that a corresponding system default file is used as the file corresponding to the instruction. For example, a system default music file or a system default picture is used as a ringtone or a desktop.

According to the file acquiring method provided in this embodiment of the present disclosure, an updated extended storage medium is searched, according to file information pre-stored in a mobile terminal, for whether there is a file matching a first file, and an acquired file matching the first file is used as the first file when the updated extended storage medium has the file matching the first file; and an acquired file meeting a predetermined condition is used as the first file when the updated extended storage medium does not have the file matching the first file, which can make it possible, in a case in which an extended storage medium is replaced, for a mobile terminal to restore a customized setting performed by a user on a file in an extended storage medium that has not been updated, thereby improving operation experience of the user.

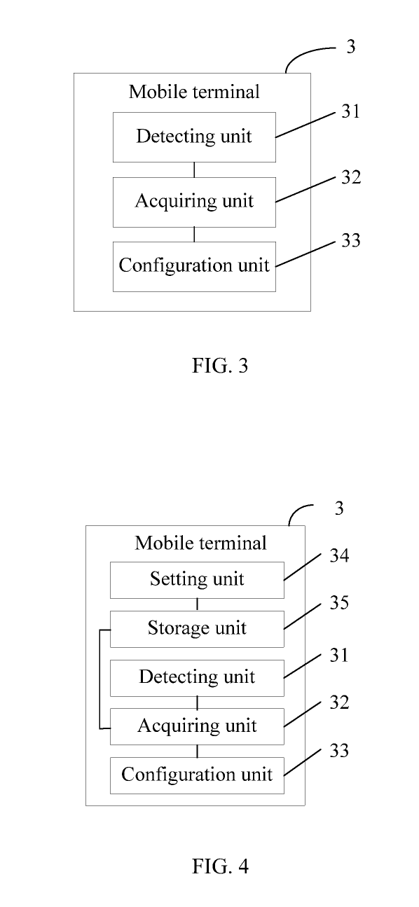

An embodiment of the present disclosure provides a mobile terminal 3. As shown in FIG. 3, the mobile terminal 3 includes a detecting unit 31 configured to detect an updated extended storage medium, where the updated extended storage medium includes at least one file; an acquiring unit 32 configured to, when an instruction is received, acquire stored file information according to the instruction; and a configuration unit 33 configured to acquire, from the updated extended storage medium according to the stored file information, a file matching a first file, and use the file as a file corresponding to the instruction, where the first file is a file selected from an extended storage medium that has not been updated, and the file information is used for guiding the mobile terminal to acquire, from a partition of the extended storage medium, the file matching the first file, and use the file as the file corresponding to the instruction.

The mobile terminal provided in this embodiment of the present disclosure detects an updated extended storage medium, selects, according to stored file information and a received instruction for acquiring a first file, a file required by a user, and then acquires a file matching the first file from the updated extended storage medium, which solves a problem that, in a case in which an extended storage medium is replaced in a mobile terminal of a user, an original file or a file similar to an original file is obtained by means of matching according to file information stored by the user, so that a use habit of the user is met from a perspective of setting, thereby improving operation experience of the user.

Optionally, the configuration unit 33 is configured to use the acquired file matching the first file as the file corresponding to the instruction when the updated extended storage medium has the file matching the first file.

Optionally, the configuration unit 33 is configured to use an acquired file meeting a predetermined condition as the file corresponding to the instruction when the updated extended storage medium does not have the file matching the first file.

Further, as shown in FIG. 4, the mobile terminal 3 further includes a setting unit 34 configured to, before the terminal detects the updated extended storage medium, receive an instruction of a user, and set a file, in the extended storage medium that has not been updated, as the first file; and a storage unit 35 configured to store file information of the first file, where the file information is used for guiding the mobile terminal to acquire, from the partition of the extended storage medium, the file matching the first file.

Optionally, the stored file information includes a file path and a file name of the first file.

Optionally, the stored file information further includes a uniform resource identifier, and the uniform resource identifier is associated with the file path and the file name of the first file.

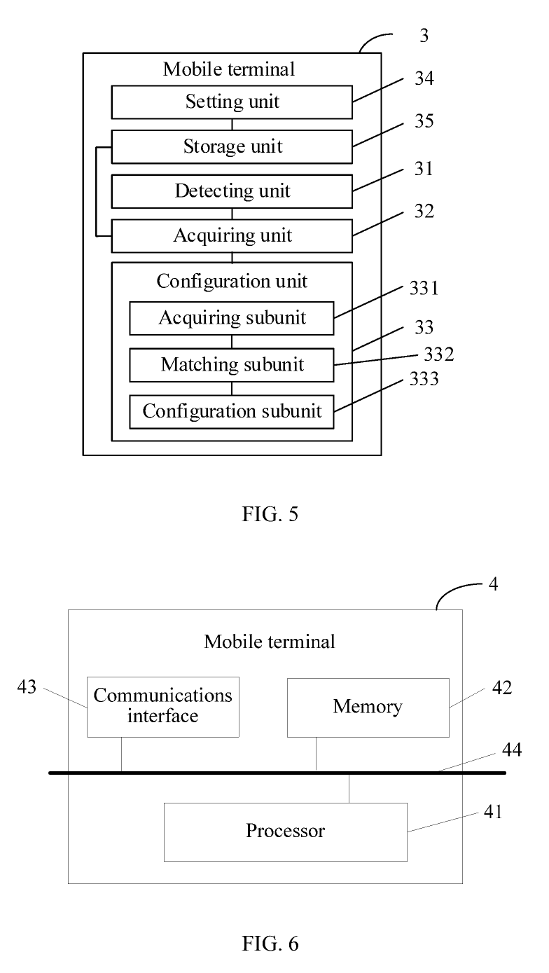

Further, as shown in FIG. 5, the mobile terminal 3 includes an acquiring subunit 331 configured to acquire attribute information of the at least one file in the updated extended storage medium; a matching subunit 332 configured to acquire a degree of matching between the at least one file and the first file according to a preset rule; and a configuration subunit 333 configured to use a file, a degree of matching between which and the first file is greater than or equal to a preset threshold, in the at least one file as the first file, or use a file, a degree of matching between which and the first file is the highest, in the at least one file as the first file.

Further, when the instruction received by the mobile terminal includes generating a ringtone, the file corresponding to the instruction includes a music file corresponding to the ringtone, and the acquiring subunit is configured to acquire at least one of a language, a style, an album, an artist, and a data size of a music file in the at least one file in the updated extended storage medium; or, when the instruction received by the mobile terminal includes displaying a desktop, the file corresponding to the instruction includes a picture file corresponding to the desktop, and the acquiring subunit is configured to acquire at least one of a style, a subject, and a data size of a picture file in the at least one file in the updated extended storage medium.

The mobile terminal provided in this embodiment of the present disclosure searches, according to file information pre-stored in the mobile terminal, an updated extended storage medium for whether there is a file matching a first file, and uses an acquired file matching the first file as the first file when the updated extended storage medium has the file matching the first file; and uses an acquired file meeting a predetermined condition as the first file when the updated extended storage medium does not have the file matching the first file, which can make it possible, in a case in which an extended storage medium is replaced, for a mobile terminal to restore a customized setting performed by a user on a file in an extended storage medium that has not been replaced, thereby improving operation experience of the user.

An embodiment of the present disclosure provides a mobile terminal 4. As shown in FIG. 6, the mobile terminal 4 includes at least one processor 41, a memory 42, a communications interface 43, and a bus 44. The at least one processor 41, the memory 42, and the communications interface 43 are connected and implement mutual communication by using the bus 44.

The bus 44 may be an industry standard architecture (ISA) bus, a peripheral component interconnect (PCI) bus, an extended industry standard architecture (EISA) bus, or the like. The bus 44 may be classified into an address bus, a data bus, a control bus, and the like. For ease of description, in FIG. 6, the bus 44 is represented by using only one bold line, but it does not mean that there is only one bus or one type of bus.

The memory 42 is configured to store executable program code, where the program code includes a computer operation instruction. The memory 42 may include a high speed random-access memory (RAM) memory, or may include a non-volatile memory, such as at least one magnetic disk memory.

The processor 41 may be a central processing unit (CPU), or an application specific integrated circuit (ASIC), or one or more integrated circuits configured to implement this embodiment of the present disclosure.

The communications interface 43 is mainly configured to implement communication between apparatuses in this embodiment.

The processor 41 may invoke the code stored in the memory 42, to perform the following actions: detecting an updated extended storage medium, where the updated extended storage medium includes at least one file; when an instruction is received, acquiring stored file information according to the instruction; and acquiring, from the updated extended storage medium according to the stored file information, a file matching a first file, and using the file as a file corresponding to the instruction, where the first file is a file selected from an extended storage medium that has not been updated, and the file information is used for guiding the mobile terminal to acquire, from a partition of the extended storage medium, the file matching the first file, and use the file as the file corresponding to the instruction.

Optionally, the acquired file matching the first file is used as the file corresponding to the instruction when the updated extended storage medium has the file matching the first file.

Optionally, an acquired file meeting a predetermined condition is used as the file corresponding to the instruction when the updated extended storage medium does not have the file matching the first file.

Optionally, before detecting the updated extended storage medium, the mobile terminal receives an instruction of a user, and sets a file, in the extended storage medium that has not been updated, as the first file; and the mobile terminal stores file information of the first file, where the file information is used for guiding the mobile terminal to acquire, from the partition of the extended storage medium, the file matching the first file.

Optionally, the stored file information includes a file path and a file name of the first file.

Optionally, the stored file information further includes a uniform resource identifier, and the uniform resource identifier is associated with the file path and the file name of the first file.

Optionally, that the acquired file meeting the predetermined condition is used as the file corresponding to the instruction when the updated extended storage medium does not have the file matching the first file includes acquiring attribute information of the at least one file in the updated extended storage medium; acquiring a degree of matching between the at least one file and the first file according to a preset rule; and using a file, a degree of matching between which and the first file is greater than or equal to a preset threshold, in the at least one file as the file corresponding to the instruction, or using a file, a degree of matching between which and the first file is the highest, in the at least one file as the file corresponding to the instruction.

Optionally, when the instruction received by the mobile terminal includes generating a ringtone, the file corresponding to the instruction includes a music file corresponding to the ringtone, and the acquiring attribute information of the at least one file in the updated extended storage medium includes acquiring at least one of a language, a style, an album, an artist, and a data size of a music file in the at least one file in the updated extended storage medium; or, when the instruction received by the mobile terminal includes displaying a desktop, the file corresponding to the instruction includes a picture file corresponding to the desktop, and the acquiring attribute information of the at least one file in the updated extended storage medium includes acquiring at least one of a style, a subject, and a data size of a picture file in the at least one file in the updated extended storage medium.

The mobile terminal provided in this embodiment of the present disclosure searches, according to file information pre-stored in the mobile terminal, an updated extended storage medium for whether there is a file matching a first file, and uses an acquired file matching the first file as the first file when the updated extended storage medium has the file matching the first file; and uses an acquired file meeting a predetermined condition as the first file when the updated extended storage medium does not have the file matching the first file, which can make it possible, in a case in which an extended storage medium is replaced, for a mobile terminal to restore a customized setting performed by a user on a file in an extended storage medium that has not been replaced, thereby improving operation experience of the user.

With the descriptions of the foregoing embodiments, a person skilled in the art may clearly understand that the present disclosure may be implemented by hardware, firmware or a combination thereof. When the present disclosure is implemented by software, the foregoing functions may be stored in a computer-readable medium or transmitted as one or more instructions or code in a computer-readable medium. The computer-readable medium includes a computer storage medium and a communications medium, where the communications medium includes any medium that facilitates transmission of a computer program from one place to another. The storage medium may be any available medium accessible to a computer. The following provides an example but does not impose a limitation. The computer-readable medium may include a RAM, a read-only memory (ROM), an electrically erasable programmable read-only memory (EEPROM), a compact disc read-only memory (CD-ROM), or another optical disc storage or disk storage medium, or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in the definition of a medium to which they belong. For example, a disk and disc used in the present disclosure include a compact disc (CD), a laser disc, an optical disc, a digital versatile disc (DVD), a floppy disk and a BLU-RAY disc, where the disk generally copies data magnetically, and the disc copies data optically by using lasers. The foregoing combination should also be included in the protection scope of the computer-readable medium.

In summary, the foregoing descriptions are merely exemplary embodiments of the technical solutions of the present disclosure, but are not intended to limit the protection scope of the present disclosure. Any modification, equivalent replacement, or improvement made without departing from the spirit and principle of the present disclosure shall fall within the protection scope of the present disclosure.

What is claimed is:

1. A file acquiring method for a terminal having a partition of an extended storage medium comprising:
detecting, by the mobile terminal, an updated extended storage medium, wherein the updated extended storage medium comprises at least one file;
acquiring, by the mobile terminal, stored file information according to an instruction when the instruction is received; and
acquiring, by the mobile terminal from the updated extended storage medium according to the stored file information, a file corresponding to the instruction by determining whether there is a file in the updated extended storage medium matching a first file,
wherein the first file is a file selected from a non-updated extended storage medium, and
wherein the file information is used for guiding the mobile terminal to the partition of the extended storage medium to determine whether there is a file in the updated extended storage medium matching the first file for acquiring the file corresponding to the instruction.

2. The method according to claim 1, wherein the method further comprises using a file matching the first file as the file corresponding to the instruction when there is the file in the updated extended storage medium matching the first file.

3. The method according to claim 1, wherein the method further comprises using a file that meets a predetermined condition as the file corresponding to the instruction when there is not a file in the updated extended storage medium matching the first file.

4. The method according to claim 1, wherein before detecting, by the mobile terminal, the updated extended storage medium, the method further comprises:
receiving an instruction of a user;
setting a file, in the non-updated extended storage medium, as the first file; and
storing file information of the first file,
wherein the file information of the first file is used for guiding the mobile terminal to acquire, from the partition of the extended storage medium, a file matching the first file.

5. The method according to claim 1, wherein the stored file information comprises a file path and a file name of the first file.

6. The method according to claim 5, wherein the stored file information further comprises a uniform resource identifier, and wherein the uniform resource identifier is associated with the file path and the file name of the first file.

7. The method according to claim 3, wherein when there is not the file in the updated extended storage medium matching the first file, using the file that meets the predetermined condition as the file corresponding to the instruction comprises:
acquiring attribute information of the at least one file in the updated extended storage medium;
acquiring a degree of matching between the at least one file and the first file according to a preset rule; and
using a file, a degree of matching between which and the first file is greater than or equal to a preset threshold, in the at least one file as the file corresponding to the instruction.

8. The method according to claim 3, wherein when there is not the file in the updated extended storage medium matching the first file, using the file that meets the predetermined condition as the file corresponding to the instruction comprises:
acquiring attribute information of the at least one file in the updated extended storage medium;
acquiring a degree of matching between the at least one file and the first file according to a preset rule; and
using a file, a degree of matching between which and the first file is the highest, in the at least one file as the file corresponding to the instruction.

9. The method according to claim 7, wherein the instruction received by the mobile terminal comprises an instruction of generating a ringtone, wherein the file corresponding to the instruction comprises a music file corresponding to the ringtone, and wherein acquiring attribute information of the at least one file in the updated extended storage medium comprises acquiring at least one of a language, a style, an album, an artist, and a data size of a music file in the at least one file in the updated extended storage medium.

10. The method according to claim 7, wherein the instruction received by the mobile terminal comprises an instruction of displaying a desktop, wherein the file corresponding to the instruction comprises a picture file corresponding to the desktop, and wherein acquiring attribute information of the at least one file in the updated extended storage medium comprises acquiring at least one of a style, a subject, and a data size of a picture file in the at least one file in the updated extended storage medium.

11. A mobile terminal having a partition of an extended storage medium, comprising:
a display unit;
a memory; and
a processor coupled with the memory,
wherein the processor is configured to:
detect an updated extended storage medium, wherein the updated extended storage medium comprises at least one file;
acquire stored file information according to an instruction in response to receiving the instruction; and
acquire, from the updated extended storage medium according to the stored file information, a file corresponding to the instruction by determining whether there is a file in the updated extended storage medium matching a first file,
wherein the first file is a file selected from a non-updated extended storage medium, and
wherein the file information is used for guiding the mobile terminal to the partition of the extended storage medium to determine whether there is a file in the updated extended storage medium matching the first file for acquiring the file corresponding to the instruction.

12. The mobile terminal according to claim 11, wherein when there is a file in the updated extended storage medium matching the first file, the processor is configured to use the file matching the first file as the file corresponding to the instruction.

13. The mobile terminal according to claim 11, wherein when there is not a file in the updated extended storage medium matching the first file, the processor is configured to use a file that meets a predetermined condition as the file corresponding to the instruction.

14. The mobile terminal according to claim 11, wherein before the updated extended storage medium is detected, the processor is configured to:
receive an instruction of a user;
set a file, in the non-updated extended storage medium, as the first file; and
store file information of the first file,
wherein the file information of the first file is used for guiding the mobile terminal to acquire, from the partition of the extended storage medium, a file matching the first file.

15. The mobile terminal according to claim 11, wherein the stored file information comprises a file path and a file name of the first file.

16. The mobile terminal according to claim 15, wherein the stored file information further comprises a uniform resource identifier, and wherein the uniform resource identifier is associated with the file path and the file name of the first file.

17. The mobile terminal according to claim 13, wherein the processor is configured to:
acquire attribute information of the at least one file in the updated extended storage medium;
acquire a degree of matching between the at least one file and the first file according to a preset rule; and
use a file, a degree of matching between which and the first file is greater than or equal to a preset threshold, in the at least one file as the file corresponding to the instruction.

18. The mobile terminal according to claim 13, wherein the processor is configured to:
acquire attribute information of the at least one file in the updated extended storage medium;
acquire a degree of matching between the at least one file and the first file according to a preset rule; and
use a file, a degree of matching between which and the first file is the highest, in the at least one file as the file corresponding to the instruction.

19. The mobile terminal according to claim 17, wherein the instruction received by the mobile terminal comprises an instruction of generating a ringtone, wherein the file corresponding to the instruction comprises a music file corresponding to the ringtone, and wherein the processor is configured to acquire at least one of a language, a style, an album, an artist, and a data size of a music file in the at least one file in the updated extended storage medium.

20. The mobile terminal according to claim 17, wherein the instruction received by the mobile terminal comprises an instruction of displaying a desktop, wherein the file corresponding to the instruction comprises a picture file corresponding to the desktop, and wherein the processor is configured to acquire at least one of a style, a subject, and a data size of a picture file in the at least one file in the updated extended storage medium.
